(19) United States
(12) Patent Application Publication
(10) Pub. No.: US 2019/0194039 A1
(43) Pub. Date: Jun. 27, 2019

(54) WATER PURIFICATION SYSTEM

(71) Applicant: HONEYWELL INTERNATIONAL INC., Morris Plains, NJ (US)

(72) Inventors: Anna LIU, Morris Plains, NJ (US); Shun ZHOU, Morris Plains, NJ (US); Li WANG, Morris Plains, NJ (US)

(21) Appl. No.: 16/306,321

(22) PCT Filed: Jun. 2, 2016
(86) PCT No.: PCT/CN2016/084474

§ 371 Date: Nov. 30, 2018

(51) Int. Cl. C02F 1/467; C02F 1/00; C02F 1/44

(52) U.S. Cl. CPC C02F 1/467; C02F 2101/20; C02F 1/441; C02F 1/004

(57) ABSTRACT

A water purification system (100) including an inlet (110) configured to accept a flow of water (105) is provided. The system (100) includes a KDF filtration stage (120) fluidly connected to the inlet (110) and including a metal alloy including elemental copper and elemental zinc. The system (100) includes a reverse osmosis stage (140) fluidly connected to the KDF stage (120). The system (100) also includes an outlet (150) fluidly connected to the reverse osmosis stage (140) and configured to output a flow of purified water (155). The reverse osmosis stage (140) is downstream of the KDF stage (120). A method of purifying water is also provided.

### BACKGROUND

Reverse osmosis household water purifiers are able to get rid of harmful impurities in water with high removal efficiency and have won a large number of markets in recent years. Commonly, one reverse osmosis household water purifier system consists of 4-5 stages of filters: poly-propylene (PP) filter, active carbon for chlorine, taste, and odor (AC/CTO), micro-filter (MF)/ultra-filter (UF), the reverse osmosis stage, and an active carbon post filter (AC/T33). The first stage is PP, which can hold up big particles such as ion rust, sand, colloids, and the like. The second stage is AC/CTO, which can block free chlorine and smells. Free chlorine can damage the reverse osmosis membrane and shorten the lifetime due to oxidation. A third stage can be a MF/UF stage to further remove some finer contaminants and protect the reverse osmosis membrane to avoid blocking. The reverse osmosis stage can be used as the fourth stage. A final stage can be AC/T33 which mainly improves the taste of the water. Normally the reverse osmosis filter needs to be replaced every 2-5 years. However the other filters usually need to be replaced every 3-12 months, with different requirements for different stages, bringing inconvenience and confusion to customers.

### SUMMARY

In various embodiments, the present subject matter provides a water purification system. The water purification system includes an inlet configured to accept a flow of water. The system includes a KDF filtration stage fluidly connected to the inlet. The KDF filtration stage includes a metal alloy. The metal alloy includes elemental copper and elemental zinc. The system includes a reverse osmosis stage fluidly connected to the KDF stage. The system includes an outlet fluidly connected to the reverse osmosis stage and configured to output a flow of purified water. The reverse osmosis stage is downstream of the KDF stage. In various embodiments, the present subject matter provides a method of using the system. The method includes flowing water into the inlet of the water purification system. The method includes flowing the water though each of the stages of the water purification stages. The method includes flowing purified water from the outlet of the water purification system.

In various embodiments, the present subject matter provides a water purification system. The water purification system includes an inlet configured to accept a flow of water. The water purification system includes a KDF filtration stage fluidly connected to the inlet. The KDF filtration stage includes a metal alloy that is a homogeneous mixture that is about 40 wt % to about 90 wt % elemental copper and about 10 wt % to about 60 wt % elemental zinc, wherein the elemental copper and the elemental zinc together are about 99.5 wt % to about 100 wt % of the metal alloy. The system includes a reverse osmosis stage fluidly connected to the KDF stage. The system includes a diatomite stage fluidly connected to the reverse osmosis stage, the diatomite stage including diatomite-based porous ceramic filtration media. The system also includes an outlet fluidly connected to the diatomite stage and configured to output a flow of purified water. The reverse osmosis stage is downstream of the KDF stage, and the diatomite stage is downstream of the reverse osmosis stage.

In various embodiments, the present subject matter provides a method of purifying water. The method includes flowing the water into an inlet configured to accept the flow of water. The method includes flowing the water from the inlet to a KDF filtration stage. The KDF filtration states is fluidly connected to the inlet and includes a metal alloy including elemental copper and elemental zinc. The method includes flowing the water from the KDF filtration stage to a reverse osmosis stage fluidly connected to the KDF stage. The method includes flowing the water from the KDF filtration stage to an outlet fluidly connected to the reverse osmosis stage and configured to output a flow of purified water. The reverse osmosis stage is downstream of the KDF stage. The method includes flowing the purified water from the outlet.

In various embodiments, the present subject matter provides a method of purifying water. The method includes flowing the water into an inlet configured to accept the flow of water. The method includes flowing the water from the inlet into a KDF filtration stage. The KDF filtration stage is fluidly connected to the inlet and includes a metal alloy that is a homogeneous mixture that is about 40 wt % to about 90 wt % elemental copper and about 10 wt % to about 60 wt % elemental zinc, wherein the elemental copper and the elemental zinc together are about 99.5 wt % to about 100 wt % of the metal alloy. The method includes flowing the water from the KDF filtration stage to a reverse osmosis stage fluidly connected to the KDF stage. The reverse osmosis stage is downstream of the KDF stage. The method includes flowing the water from the KDF filtration stage to a diatomite stage fluidly connected to the reverse osmosis stage, the diatomite stage including diatomite-based porous ceramic filtration media. The diatomite stage is downstream of the reverse osmosis stage. The method includes flowing the water from the diatomite stage to an outlet fluidly connected to the diatomite stage and configured to output a flow of purified water. The method includes flowing the purified water from the outlet.

Various embodiments of the present subject matter have certain advantages over other water purification systems and methods of using the same, at least some of which are unexpected. For example, in various embodiments, the present subject matter provides a reverse osmosis water filtration system having fewer total stages than other water filtration systems. In various embodiments, the present subject matter provides a reverse osmosis water filtration system that requires less filter changes during its lifetime as compared to other water filtration systems such as other reverse osmosis water filtration systems, or that requires no filter changes during its lifetime. In various embodiments, the reverse osmosis water purification system of the present subject matter can have a longer service life than other water purification systems.

In various embodiments, the reverse osmosis water filtration system of the present subject matter can have reduced mineral scale as compared to other water filtration systems. In some embodiments, the KDF stage can raise the pH of the water via electrochemical reactions, reducing the solubility of calcium carbonate and resulting in a reduction of calcium carbonate scale. In some embodiments, Zn ions released from the KDF stage can cause precipitated calcium carbonate to form as aragonite, a softer form of mineral scale which can be easily removed by water flow.

In various embodiments, the reverse osmosis water filtration system of the present subject matter can provide reduced suspended contaminants as compared to other water filtration systems. In various embodiments, the KDF stage can effectively remove small suspended contaminants, such as having a diameter of 50 microns or larger. FeO can be generated from a variety of sources, including from corroding iron- or steel-containing pipes; in various embodiments, the KDF filter can eliminate FeO via a redox reaction (forming Fe₂O₃ as a deposit on the surface of the metal alloy).

In various embodiments, the reverse osmosis water filtration system of the present subject matter can provide reduced concentration of oxidants such as halides and ozone as compared to other water filtration systems, or can completely remove the oxidants. In the metal alloy, copper with a positive potential can act as a cathode, and zinc with a negative potential can act as an anode, which together can electrochemically reduce oxidants such as chlorine, bromine, iodine, and ozone.

In various embodiments, the reverse osmosis water filtration system of the present subject matter can inhibit the breeding of microbes more than other water filtration systems. In various embodiments, the KDF filter can cause a change in the oxidation reduction potential of water flowing therethough, destroying microbes and inhibiting their growth. In various embodiments, the KDF filter can form hydroxy ions and hydrogen peroxide, such as via oxidation of ferric ions from a divalent trivalent state. The produced hydroxy ions and hydrogen peroxide can inhibit growth of microbes, such as microbes that can survive the redox environment of the KDF stage. Hydroxy ions and hydrogen peroxide can have a short lifetime, substantially confining the effects of these materials to the filtration system itself and not to the purified water produced. In various embodiments, zinc ions released from the KDF stage can inhibit breeding of microbes, such as by preventing enzyme synthesis. The KDF stage can prevent the synthesis of chlorophyll and can inhibit the growth of algae, which in turn can further inhibit growth of bacteria.

In various embodiments, the reverse osmosis water purification system of the present subject matter can remove a greater amount or variety of heavy metal ions as compared to other water filtration systems, such as lead, mercury, copper, nickel, cadmium, arsenic, antimony, and other soluble heavy metal ions. Heavy metal ions can be plated onto the surface of the metal alloy via electrochemical redox reactions and catalysis reactions. Heavy metal ions can be removed via metal hydroxide precipitation, which can be aided via the raised pH caused by the metal alloy.

In various embodiments, the reverse osmosis water purification system of the present subject matter can avoid contamination of the reverse osmosis membrane surface with sulfur compounds due to oxidation of hydrogen sulfide more effectively than other reverse osmosis water purification systems. The KDF metal alloy can transform hydrogen sulfide to insoluble copper sulfide which can be held up with the KDF stage rather than deposited on the reverse osmosis membrane.

### BRIEF DESCRIPTION OF THE FIGURES

The drawings illustrate generally, by way of example, but not by way of limitation, various embodiments discussed in the present document.

FIG. 1 illustrates a water purification system, in accordance with various embodiments.

FIG. 2 illustrates a water purification system, in accordance with various embodiments.

### DETAILED DESCRIPTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in any order without departing from the principles of the subject matter, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%.

### Water Purification System.

In various embodiments, the present subject matter provides a water purification system. The water purification system can include an inlet configured to accept a flow of water. The water purification system can include a KDF filtration stage fluidly connected to the inlet. The water purification system can include a reverse osmosis stage fluidly connected to the KDF stage. The water purification system can also include an outlet fluidly connected to the reverse osmosis stage and configured to output a flow of purified water. The purified water is the water that initially flowed into the water purification system but without the impurities that were removed by the water purification system.

Each filtration stage of the water purification system can be independently contained within a suitable container, such as a cartridge, such as a cylindrical cartridge having an inlet and an outlet. For example, the KDF filtration stage can include a cartridge filled with the metal alloy in particulate form, wherein the cartridge has an inlet and an outlet such that water entering the inlet must travel through the metal alloy filtration media to reach the outlet. Likewise, the reverse osmosis stage can include a cartridge that includes a reverse osmosis membrane, including an inlet that is fluidly connected to one side of the membrane and an outlet that is fluidly connected to the other side of the membrane. An optional diatomite stage can include a cartridge including diatomite filtration media and including an inlet and an outlet.

The fluid connections can each independently be any suitable fluid connection. The fluid connections can independently include one or more pipes, tubing, or any suitable conduit for liquid flow. A fluid connection can be a direct fluid connection, such that fluid can flow directly between stages or directly between the inlet or outlet and the stage without passing through any other filtration stage therebetween. The fluid connection can be an indirect fluid connection, such that the fluid can flow between stages or between the inlet or outlet and the stage only after passing through another one or more stages. The fluid connection can be a unitary fluid connection, such that fluid can only flow between the respective stages or between the inlet or outlet and a stage without flowing to any other location. The fluid connection can be a divided fluid connection, such that only a portion of the fluid flows between the respective stages of between the inlet or outlet and a stage while another portion flows to another stage (e.g., an identical parallel stage).

In some embodiments, the water purification system can be free of additional filtration stages (e.g., stages that remove impurities) other than the KDF filtration stage and the reverse osmosis stage. The water purification system can optionally include a diatomite stage, such as downstream of the reverse osmosis stage. In some embodiments, the water purification system can be free of additional filtration stages other than the KDF filtration stage, the reverse osmosis stage, and the diatomite stage.

The water purification system can include a polypropylene stage, such as an initial polypropylene stage that is upstream or downstream of the KDF stage but upstream of the reverse osmosis stage. In some embodiments, the water purification system can be free of a polypropylene stage.

The water purification system can include activated carbon, such as in the KDF stage, or such as in an independent activated carbon stage (e.g., a stage that includes activated carbon), such as before or after the reverse osmosis stage. In some embodiments, the water purification system is free of stages that include activated carbon. In some embodiments, the water purification system is free of stages that include activated carbon other than the KDF stage.

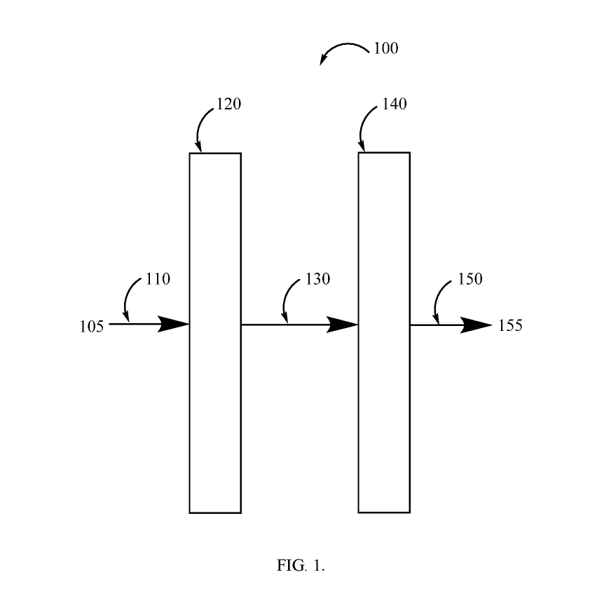

FIG. 1 illustrates an embodiment of the water purification system, 100. The water purification system 100 includes an inlet 110 configured to accept a flow of water 105. The water purification system 100 includes a KDF filtration stage 120 fluidly connected to the inlet 110 and including a metal alloy including elemental copper and elemental zinc (not shown). The inlet 110 is directly fluidly connected to the KDF stage 120. The water purification system 100 can include a reverse osmosis stage 140 fluidly connected to the KDF stage 120 via fluid connection 130. The reverse osmosis stage 140 is downstream of the KDF filtration stage 120. The reverse osmosis stage 140 is directly fluidly connected to KDF stage 120 via fluid connection 130. The water purification system 100 includes an outlet 150. The outlet 150 is directly fluidly connected to the reverse osmosis stage 140. The outlet 150 is configured to output a flow of purified water 155.

### KDF Stage.

The water purification system includes a KDF stage. For example, the water purification system can include a KDF filtration stage fluidly connected to the inlet. The KDF stage includes KDF filtration media, also called kinetic degradation fluxion media. KDF filtration media is a metal alloy including elemental copper and elemental zinc. The metal alloy can utilize the principle of electrochemical oxidation reduction (e.g., “redox”) to eliminate a vast number of contaminants from water. The copper and zinc in the metal alloy can act as a miniature electrolytic cell, with the zinc acting as the anode and the copper acting as the cathode, and the water and the impurities therein acting as the electrolyte through which the charge flows. Some contaminants and impurities can react to the magnetic force exerted by the electrolytic cell and can be attracted to the surface of the metal alloy where they can adhere. Other impurities can undergo a chemical reaction with the metal alloy to form salts such as oxides, hydroxides, and sulfates. The KDF media can also block particulate contaminants like a regular porous filter.

The metal alloy can be a substantially homogeneous mixture of the elemental copper and the elemental zinc. In some embodiments, the metal alloy can be a substantially homogeneous mixture of the elemental copper and the elemental zinc; in other embodiments, the metal alloy can be a heterogeneous mixture of the elemental copper and the elemental zinc. The metal alloy can be in any suitable form, such as chips, flakes, granulated particles, or a combination thereof. The metal alloy can have any suitable particle size (e.g., the largest dimension of the particle), such as about 0.0001 mm to about 10 mm, or about 0.1 mm to about 5 mm, or about 0.0001 mm or less, or less than, equal to, or greater than about 0.001 mm, 0.1, 1, 2, 3, 4, 5, 6, 7, 8, 9, or about 10 mm or more.

The elemental copper can form any suitable proportion of the metal alloy. The metal alloy can be about 1 wt % to about 99 wt % elemental copper, or about 40 wt % to about 90 wt %, or about 1 wt % or less, or less than, equal to, or greater than about 5 wt %, 10, 15, 20, 25, 30, 35, 40, 42, 44, 46, 48, 50, 52, 54, 56, 58, 60, 62, 64, 66, 68, 70, 72, 74, 76, 78, 80, 82, 84, 86, 88, 90, 95, 97 wt %, or about 99 wt % or more elemental copper.

The elemental zinc can form any suitable proportion of the metal alloy. The metal alloy can be about 1 wt % to about 99 wt % elemental zinc, or about 10 wt % to about 60 wt % wt %, or about 1 wt % or less, or less than, equal to, or greater than about 5 wt %, 10, 12, 14, 16, 18, 20, 22, 24, 26, 28, 30, 32, 34, 36, 38, 40, 42, 44, 46, 48, 50, 52, 54, 56, 58, 60, 65, 70, 75, 80, 85, 90, 95, 97, or about 99 wt % or more elemental zinc.

The metal alloy can be about 50 wt % elemental copper and about 50 wt % elemental zinc (e.g., KDF® 55 process medium), of about 85 wt % elemental copper and about 15 wt % elemental zinc (e.g., KDF® 85 process medium).

The metal alloy can be a very pure form of the alloy of elemental copper and elemental zinc. The elemental copper and the elemental zinc together can form about 50 wt % to about 100 wt % of the metal alloy, about 80 wt % to about 100 wt %, or about 99.5 wt % to about 100 wt %, or about 50 wt % or less, or less than, equal to, or greater than about 55 wt %, 60, 65, 70, 75, 80, 82, 84, 85, 86, 87, 88, 89, 90, 91, 92, 93, 94, 95, 95.5, 96, 96.5, 97, 97.5, 98, 98.5, 99, 99.1, 99.2, 99.3, 99.4, 99.5, 99.6, 99.7, 99.8, 99.9, 99.95, 99.99, 99.995, or about 99.999 wt % or more.

The KDF filtration stage can include the metal alloy placed directly in a cartridge, or can include a combination (e.g., a homogeneous mixture) of the metal alloy and other materials placed in the cartridge. In addition to the metal alloy, the KDF stage can include any suitable filtration media. In some embodiments, the KDF stage includes activated carbon. The activated carbon can form any suitable weight proportion of the total amount of filtration media present in the KDF stage, such as about 5 wt % to about 80 wt %, or about 25 wt % to about 50 wt %, or about 5 wt % or less, or less than, equal to or more than about 10 wt %, 15, 20, 25, 30, 35, 40, 45, 50, 55, 60, 65, 70, 75, or about 80 wt % or more. In various embodiments, the KDF stage can be free of filtration media other than the metal alloy and the activated carbon. In some embodiments, the KDF stage is free of activated carbon.

### Reverse Osmosis Stage.

The water filtration system includes a reverse osmosis stage. For example the water filtration can include a reverse osmosis stage fluidly connected to the KDF stage, and downstream of the KDF stage. The reverse osmosis stage uses a semipermeable membrane to remove ions, molecules and larger particles from the water. The reverse osmosis stage uses pressure to overcome osmotic pressure to retain solutes on the inlet side of the semipermeable membrane and to force water through the membrane to the outlet side. The water forced through the membrane has greater purity due to straining or size exclusion as the water passes through the membrane. The pressure can be a natural pressure from the incoming water or can be a generated pressure from a pump or compressor that is part of the reverse osmosis stage. The pressure can be any suitable pressure, such as about 0.1 MPa to about 100 MPa, about 0.5 MPa to about 50 MPa, or about 1 MPa to about 10 MPa.

The reverse osmosis stage can include one or more semipermeable membranes. The membrane can be any suitable membrane. The membrane can have any suitable surface area. The membrane can have any suitable layout, such as flat, coiled, hollow fibers, and the like. The membrane can have any suitable maximum pore size, and any suitable average pore size, such as about 0.1 nm to about 5,000 nm, or about 0.1 nm or less, or less than, equal to, or greater than about 0.2 nm, 0.3, 0.4, 0.5, 0.6, 0.7, 0.8, 0.9, 1, 1.5, 2, 3, 4, 5, 6, 8, 10, 12, 14, 16, 18, 20, 25, 30, 35, 40, 45, 50, 60, 70, 80, 90, 100, 125, 150, 175, 200, 250, 300, 350, 400, 500, 600, 700, 800, 900, 1,000, 1,500, 2,000, 2,500, 3,000, 3,500, 4,000, 4,500, or a maximum pore size or average pore size of about 5,000 nm or more.

In some embodiments, the reverse osmosis stage can block some or all Zn ions in the incoming water, such as Zn ions released by the KDF stage.

### Diatomite Stage.

In various embodiments, the water purification system includes a diatomite stage. For example the water purification system can include a diatomite stage fluidly connected to the reverse osmosis stage. The outlet can be fluidly connected to the diatomite stage. The diatomite stage can be downstream of the reverse osmosis stage. The diatomite stage can have a longer lifetime than active carbon filters, such as about 5 years, 6, 8, 10, 12, 14, 16, 18, or about 20 or more years. The diatomite stage can improve the taste of the purified water generated by the water purification system.

The diatomite stage can include a diatomite-based porous ceramic filtration media. The filtration media can have a high adsorption capacity for organic impurities. The filtration media can be a sintered ceramic filter formed from diatomite (e.g., diatomaceous earth) as a raw material and including one or more additives. The naturally occurring fossilized remains of diatoms have innate filtering characteristics that are due, for example, to their honeycomb structure.

The diatomite-based porous ceramic filtration media can have any suitable particle size, such as about 1 nm to about 5 mm, or about 1 micron to about 1 mm.

The diatomite-based porous ceramic filtration media can have any suitable crushing strength, such as about 0.1 MPa to about 100 MPa, or about 0.5 MPa to about 20 MPa, or about 1 MPa to about 10 MPa.

The diatomite-based porous ceramic filtration media can have any suitable average pore diameter, such as about 0.1 micron to about 100 microns, or about 0.5 microns to about 50 microns, or about 1 micron to about 20 microns.

The diatomite-based porous ceramic filtration media can have any suitable specific surface area, such as about 50 m²/g to about 800 m²/g, or about 100 m²/g to about 500 m²/g, or about 200 m²/g to about 300 m²/g.

The diatomite-based porous ceramic filtration media can be a sintered ceramic particles formed from diatomite (e.g., diatomaceous earth) as a raw material and including sodium carbonate and polyvinyl alcohol as additives. In one example, diatomite-based porous ceramic filtration media can be formed from about 100 portions of calcined diatomite, about 10 portions of sodium carbonate, and about 150 portions of water, PVA and polyacrylamide (PAM) solution[m(H₂O):m(PVA):m(PAM)=1000:4:4], which can be sintered at 900 C to provide a diatomite-based porous ceramic filtration media having a porosity, crushing strength, average pore diameter, and specific surface area of about 71.74%, about 4.535 MPa, about 10.023 μm, and about 230 m²/g, respectively.

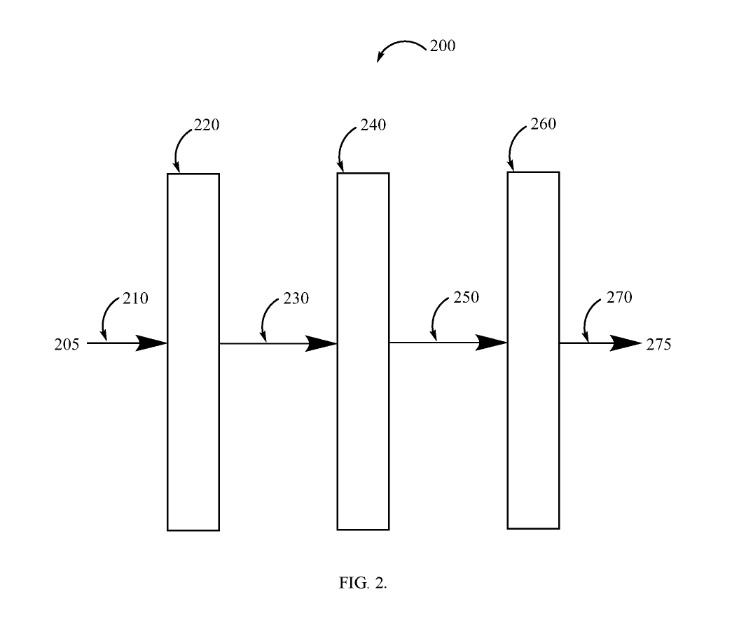

FIG. 2 illustrates an embodiment of the water purification system 200. The water purification system 200 includes an inlet 205 configured to accept a flow of water 205. The water purification system 200 includes a KDF filtration stage 220. The KDF filtration stage 220 is directly fluidly connected to the inlet 210. The KDF filtration stage 220 includes a metal alloy (not shown) that is a homogeneous mixture that is about 40 wt % to about 90 wt % elemental copper and about 10 wt % to about 60 wt % elemental zinc. The elemental copper and the elemental zinc together are about 99.5 wt % to about 100 wt % of the metal alloy. The system 200 includes a reverse osmosis stage 240 that is directly fluidly connected to the KDF stage 220 via fluid connection 230. The reverse osmosis stage 240 is downstream of the KDF stage 220. The system 200 includes a diatomite stage 260 that is directly fluidly connected to the reverse osmosis stage 240 via fluid connection 250. The diatomite stage 260 is downstream of the reverse osmosis stage 240. The system 200 also includes outlet 270 that is directly fluidly connected to the diatomite stage 260. The outlet 270 is configured to output a flow of purified water 275.

### Method of Purifying Water.

In various embodiments, the present subject matter provides a method of purifying water. The method can be any suitable method of using an embodiment of a system for water purification described herein to purify water. For example, the method can include flowing water into the inlet of the water purification system. The method can include flowing the water through each of the stages of the water purification system. The method can include flowing purified water from the output of the water purification system.

The method of purifying water can include flowing the water to be purified into an inlet configured to accept the flow of water. The method can include flowing the water from the inlet to a KDF filtration stage fluidly connected to the inlet. The KDF filtration stage can include a metal alloy including elemental copper and elemental zinc. The method can include flowing the water from the KDF filtration stage to a reverse osmosis stage fluidly connected to the KDF stage. The reverse osmosis stage can be downstream of the KDF filtration stage. The method can include flowing the water from the reverse osmosis stage to an output fluidly connected to the reverse osmosis stage and configured to output a flow of purified water.

The method of purifying water can include flowing the water to be purified into an inlet configured to accept the flow of water. The method can include flowing the water from the inlet to a KDF filtration stage fluidly connected to the inlet. The KDF filtration stage can include a metal alloy that is a homogeneous mixture that is about 40 wt % to about 90 wt % elemental copper and about 10 wt % to about 60 wt % elemental zinc. The elemental copper and the elemental zinc together can be about 99.5 wt % to about 100 wt % of the metal alloy. The method can include flowing the water from the KDF filtration stage to a reverse osmosis stage fluidly connected to the KDF stage. The reverse osmosis stage can be downstream of the KDF filtration stage. The method can include flowing the water from the reverse osmosis stage to a diatomite stage. The diatomite stage can be downstream of the reverse osmosis stage. The method can include flowing water from the diatomite stage to an output fluidly connected to the reverse osmosis stage and configured to output a flow of purified water.

Flowing the water from the inlet to a stage, from stage to stage, or from stage to outlet, can be any suitable flowing. The flowing can occur via any suitable fluid connection described herein. The flowing can be a direct flowing, such that the fluid flows directly between stages or between the inlet or outlet and the stage without passing through any other filtration stage therebetween. The flowing can be an indirect flowing, such that the fluid can flow between stages or between the inlet or outlet and the stage only after passing through another one or more filtration stages. The flowing can be a unitary flowing, such that the water is only flowed to the particular stage or outlet. The flowing can be a divided flowing, such that only a portion of the fluid flows to the stage or outlet while another portion of the fluid flows to another stage (e.g., an identical parallel stage).

In some embodiments, the method can be free of flowing the water through additional filtration stages (e.g., stages that remove impurities) other than the KDF filtration stage and the reverse osmosis stage. The method can optionally include flowing the water through a diatomite stage, such as downstream of the reverse osmosis stage. In some embodiments, the method can be free of flowing the water through additional filtration stages other than the KDF filtration stage, the reverse osmosis stage, and the diatomite stage.

The method can include flowing the water through a polypropylene stage, such as an initial polypropylene stage that is upstream or downstream of the KDF stage but upstream of the reverse osmosis stage. In some embodiments, the method can be free of flowing water through a polypropylene stage.

The method can include flowing the water through activated carbon, such as in the KDF stage, or such as in an independent activated carbon stage (e.g., a stage that includes activated carbon), such as before or after the reverse osmosis stage. In some embodiments, the method can be free of flowing water through stages that include activated carbon. In some embodiments, the method can be free of flowing water through stages that include activated carbon other than the KDF stage.

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present subject matter. Thus, it should be understood that although the present subject matter has been specifically disclosed by specific embodiments and optional features, modification and variation of the concepts herein disclosed may be resorted to by those of ordinary skill in the art, and that such modifications and variations are considered to be within the scope of embodiments of the present subject matter.

### Additional Embodiments

The following exemplary embodiments are provided, the numbering of which is not to be construed as designating levels of importance:

Embodiment 1 provides a water purification system comprising:

an inlet configured to accept a flow of water;

a KDF filtration stage fluidly connected to the inlet and comprising a metal alloy comprising elemental copper and elemental zinc;

a reverse osmosis stage fluidly connected to the KDF stage; and

an outlet fluidly connected to the reverse osmosis stage and configured to output a flow of purified water;

wherein the reverse osmosis stage is downstream of the KDF stage.

Embodiment 2 provides the water purification system of Embodiment 1, wherein the metal alloy is a substantially homogeneous mixture of the elemental copper and the elemental zinc.

Embodiment 3 provides the water purification system of any one of Embodiments 1-2, wherein about 1 wt % to about 99 wt % of the metal alloy is the elemental copper.

Embodiment 4 provides the water purification system of any one of Embodiments 1-3, wherein about 40 wt % to about 90 wt % of the metal alloy is the elemental copper.

Embodiment 5 provides the water purification system of any one of Embodiments 1-4, wherein about 1 wt % to about 99 wt % of the metal alloy is the elemental zinc.

Embodiment 6 provides the water purification system of any one of Embodiments 1-5, wherein about 10 wt % to about 60 wt % of the metal alloy is the elemental zinc.

Embodiment 7 provides the water purification system of any one of Embodiments 1-6, wherein the elemental copper and the elemental zinc together are about 50 wt % to about 100 wt % of the metal alloy.

Embodiment 8 provides the water purification system of any one of Embodiments 1-7, wherein the elemental copper and the elemental zinc together are about 99.5 wt % to about 100 wt % of the metal alloy.

Embodiment 9 provides the water purification system of any one of Embodiments 1-8, wherein the metal alloy is in the form of chips, flakes, granulated particles, or a combination thereof.

Embodiment 10 provides the water purification system of any one of Embodiments 1-9, wherein the KDF filtration stage further comprises activated carbon.

Embodiment 11 provides the water purification system of any one of Embodiments 1-10, wherein the reverse osmosis stage comprises a semipermeable membrane.

Embodiment 12 provides the water purification system of Embodiment 11, wherein the semipermeable membrane comprises a maximum pore size of about 0.1 nm to about 5,000 nm.

Embodiment 13 provides the water purification system of any one of Embodiments 11-12, wherein the semipermeable membrane comprises a maximum pore size of about 0.5 nm.

Embodiment 14 provides the water purification system of any one of Embodiments 1-13, further comprising a diatomite stage fluidly connected to the reverse osmosis stage, wherein the outlet is fluidly connected to the diatomite stage, wherein the diatomite stage is downstream of the reverse osmosis stage.

Embodiment 15 provides the water purification system of any one of Embodiments 1-14, wherein the diatomite stage comprises a diatomite-based porous ceramic filtration media.

Embodiment 16 provides the water purification system of any one of Embodiments 1-15, wherein the water purification system is free of a polypropylene stage, an activated carbon stage, or a combination thereof.

Embodiment 17 provides a method of purifying water, the method comprising:

flowing water into the inlet of the water purification system of any one of Embodiments 1-16;

flowing the water through each of the stages of the water purification system of any one of Embodiments 1-16; and

flowing purified water from the outlet of the water purification system of any one of Embodiments 1-16.

Embodiment 18 provides a water purification system comprising:

an inlet configured to accept a flow of water;

a KDF filtration stage fluidly connected to the inlet and comprising a metal alloy that is a homogeneous mixture that is about 40 wt % to about 90 wt % elemental copper and about 10 wt % to about 60 wt % elemental zinc, wherein the elemental copper and the elemental zinc together are about 99.5 wt % to about 100 wt % of the metal alloy;

a reverse osmosis stage fluidly connected to the KDF stage;

a diatomite stage fluidly connected to the reverse osmosis stage, the diatomite stage comprising diatomite-based porous ceramic filtration media; and

an outlet fluidly connected to the diatomite stage and configured to output a flow of purified water;

wherein the reverse osmosis stage is downstream of the KDF stage, and the diatomite stage is downstream of the reverse osmosis stage.

Embodiment 19 provides a method of purifying water, the method comprising:

flowing the water into an inlet configured to accept the flow of water;

flowing the water from the inlet to a KDF filtration stage fluidly connected to the inlet and comprising a metal alloy comprising elemental copper and elemental zinc;

flowing the water from the KDF filtration stage to a reverse osmosis stage fluidly connected to the KDF stage;

flowing the water from the KDF filtration stage to an outlet fluidly connected to the reverse osmosis stage and configured to output a flow of purified water; and

flowing the purified water from the outlet;

wherein the reverse osmosis stage is downstream of the KDF stage.

Embodiment 20 provides a method of purifying water, the method comprising:

flowing the water into an inlet configured to accept the flow of water;

flowing the water from the inlet into a KDF filtration stage fluidly connected to the inlet and comprising a metal alloy that is a homogeneous mixture that is about 40 wt % to about 90 wt % elemental copper and about 10 wt % to about 60 wt % elemental zinc, wherein the elemental copper and the elemental zinc together are about 99.5 wt % to about 100 wt % of the metal alloy;

flowing the water from the KDF filtration stage to a reverse osmosis stage fluidly connected to the KDF stage;

flowing the water from the KDF filtration stage to a diatomite stage fluidly connected to the reverse osmosis stage, the diatomite stage comprising diatomite-based porous ceramic filtration media;

flowing the water from the diatomite stage to an outlet fluidly connected to the diatomite stage and configured to output a flow of purified water; and

flowing the purified water from the outlet;

wherein the reverse osmosis stage is downstream of the KDF stage, and the diatomite stage is downstream of the reverse osmosis stage.

Embodiment 21 provides the water purification system or method of purifying water of any one or any combination of Embodiments 1-20 optionally configured such that all elements or options recited are available to use or select from.

What is claimed is:

1. A water purification system comprising:
an inlet configured to accept a flow of water;
a KDF filtration stage fluidly connected to the inlet and comprising a metal alloy comprising elemental copper and elemental zinc;
a reverse osmosis stage fluidly connected to the KDF stage; and
an outlet fluidly connected to the reverse osmosis stage and configured to output a flow of purified water;
wherein the reverse osmosis stage is downstream of the KDF stage.

2. A method of purifying water, the method comprising:
flowing water into the inlet of the water purification system of claim 1;
flowing the water through each of the stages of the water purification system of claim 1; and
flowing purified water from the outlet of the water purification system of claim 1.

3. The water purification system of claim 1, wherein about 1 wt % to about 99 wt % of the metal alloy is the elemental copper.

4. The water purification system of claim 1, wherein about 1 wt % to about 99 wt % of the metal alloy is the elemental zinc.

5. The water purification system of claim 1, wherein the elemental copper and the elemental zinc together are about 50 wt % to about 100 wt % of the metal alloy.

6. The water purification system of claim 1, wherein the KDF filtration stage further comprises activated carbon.

7. The water purification system of claim 1, further comprising a diatomite stage fluidly connected to the reverse osmosis stage, wherein the outlet is fluidly connected to the diatomite stage, wherein the diatomite stage is downstream of the reverse osmosis stage.

8. The water purification system of claim 1, wherein the diatomite stage comprises a diatomite-based porous ceramic filtration media.

9. A water purification system comprising:
an inlet configured to accept a flow of water;
a KDF filtration stage fluidly connected to the inlet and comprising a metal alloy that is a homogeneous mixture that is about 40 wt % to about 90 wt % elemental copper and about 10 wt % to about 60 wt % elemental zinc, wherein the elemental copper and the elemental zinc together are about 99.5 wt % to about 100 wt % of the metal alloy;
a reverse osmosis stage fluidly connected to the KDF stage;
a diatomite stage fluidly connected to the reverse osmosis stage, the diatomite stage comprising diatomite-based porous ceramic filtration media; and
an outlet fluidly connected to the diatomite stage and configured to output a flow of purified water;
wherein the reverse osmosis stage is downstream of the KDF stage, and the diatomite stage is downstream of the reverse osmosis stage.

10. A method of purifying water, the method comprising:
flowing the water into an inlet configured to accept the flow of water;
flowing the water from the inlet to a KDF filtration stage fluidly connected to the inlet and comprising a metal alloy comprising elemental copper and elemental zinc;
flowing the water from the KDF filtration stage to a reverse osmosis stage fluidly connected to the KDF stage;
flowing the water from the KDF filtration stage to an outlet fluidly connected to the reverse osmosis stage and configured to output a flow of purified water; and
flowing the purified water from the outlet;
wherein the reverse osmosis stage is downstream of the KDF stage.
